(19) United States
(12) Patent Application Publication
(10) Pub. No.: US 2025/0280103 A1
(43) Pub. Date: Sep. 4, 2025

(54) WEARABLE APPARATUS AND DRIVING METHOD THEREOF

(71) Applicant: LG Display Co., Ltd., Seoul (KR)

(72) Inventors: Ju Seong PARK, Paju-si (KR); Joung Won WOO, Paju-si (KR); Wook JEON, Paju-si (KR)

(21) Appl. No.: 18/979,164

(22) Filed: Dec. 12, 2024

(30) Foreign Application Priority Data
Feb. 29, 2024 (KR) 10-2024-0029839

(51) Int. Cl. H04N 13/366; G02B 30/27; G02B 30/30; G04G 9/00; H04N 13/305; H04N 13/31; H04N 13/398

(52) U.S. Cl. CPC H04N 13/366; H04N 13/305; H04N 13/31; H04N 13/398; G02B 30/27; G02B 30/30; G04G 9/007

(57) ABSTRACT

Disclosed herein are a wearable device and a driving method thereof. The wearable device includes a display panel including a display area in which pixels are disposed and a non-display area surrounding the display area, a barrier layer disposed on the display area, a lenticular lens layer disposed on the barrier layer, and a distance sensor disposed in the non-display area or outside the display panel.

### CROSS-REFERENCE TO RELATED APPLICATION

This application claims priority to and the benefit of Korean Patent Application No. 10-2024-0029839, filed on Feb. 29, 2024, the disclosure of which is incorporated herein by reference in its entirety.

### BACKGROUND

### Technical Field

The present disclosure relates to a wearable device and a driving method thereof.

### Description of the Related Art

Electroluminescence display devices may be divided into inorganic light-emitting display devices and organic light-emitting display devices depending on the material of the light-emitting layer. Organic light-emitting display devices not only have fast response speeds and excellent light emission efficiency, brightness, and viewing angles but also have excellent contrast ratios and color reproducibility because the organic light emitting display devices can exhibit black gradations in complete black.

Due to the development of stereoscopic image display technology, stereoscopic image reproduction technology has been applied to display devices, such as televisions and monitors, making it possible to enjoy three-dimensional (3D) stereoscopic images even at home. Stereoscopic image display devices may be divided into glasses type display devices and glasses-free type display devices. Among the stereoscopic image display devices, the glasses-free type display devices generally use optical components, such as a parallax barrier (hereinafter referred to as a “barrier”) and a lenticular lens (hereinafter referred to as a “lens”) for separating the optical axes of left and right parallax images, installed in front of or behind a display screen to implement 3D images.

### BRIEF SUMMARY

Conventionally, stereoscopic imaging technology has been applied to stationary or large-screen display devices. However, the inventors of the present disclosure have developed various embodiments that apply this technology to portable electronic devices, such as wearable devices (e.g., smartwatches) with small viewing distances, a challenge that has been difficult to implement in the industry. The various embodiments of present disclosure address multiple technical problems found in the related art, including the above-described needs and problems.

The present disclosure is directed to providing a wearable device and a driving method thereof, which execute a three-dimensional (3D) image or a linked application on the basis of a distance value measured by a distance sensor.

It should be noted that technical benefits of the present disclosure are not limited to the above-described benefits, and other benefits of the present disclosure will be apparent to those skilled in the art from the following descriptions.

According to an aspect of the present disclosure, there is provided a wearable device including a display panel including a display area in which pixels are disposed and a non-display area surrounding the display area, a barrier layer disposed on the display area, a lenticular lens layer disposed on the barrier layer, and a distance sensor disposed in the non-display area or outside the display panel.

According to another aspect of the present disclosure, there is provided a method of driving a wearable device, which includes measuring, by a distance sensor, a face or finger of a user; when a measured distance is within a sensing distance range, calculating, by a controller, user location information; transmitting, by a display module, a stereoscopic image based on a location of the user; when the measured distance is within a hovering distance range, analyzing, by the distance sensor, a location and a movement direction of an object within a hovering range; executing, by a controller, a linked application of the wearable device according to the movement direction; and when the measured distance is out of the sensing distance range suitable for outputting the stereoscopic image and the hovering distance range, outputting a general image.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a wearable device according to an embodiment of the present disclosure;

FIG. 2 is a diagram illustrating the exterior of a smart watch type wearable device;

FIGS. 3A to 3C are diagrams illustrating a display unit of the wearable device in which a distance sensor is disposed according to various embodiments of the present disclosure;

FIG. 4 is a schematic cross-sectional view along line A-A′ of FIG. 3A;

FIG. 5 is an enlarged cross-sectional view of portion B of FIG. 4;

FIG. 6 is an enlarged cross-sectional view of portion C of FIG. 4;

FIG. 7 is a diagram illustrating a display further including light blocking patterns for preventing the generation of partial images according to the present disclosure;

FIG. 8 is a diagram illustrating an effective sensing distance and a hovering sensing distance;

FIG. 9 is a flowchart illustrating an example of a sensing method using a distance sensor; and

FIGS. 10A and 10B are diagrams illustrating a change in an image section within a display panel when a user moves within an effective sensing distance range.

### DETAILED DESCRIPTION

Advantages, features, and implementations thereof will be apparent from embodiments which are described in detail below together with the accompanying drawings. The present disclosure may be implemented in many different forms and should not be construed as being limited to the embodiments set forth herein, and the embodiments are provided such that this disclosure will be thorough and complete and will fully convey the scope of the present disclosure to those skilled in the art to which the present disclosure pertains, and the present disclosure is defined by only the scope of the appended claims.

Shapes, sizes, dimensions (e.g., length, width, height, thickness, radius, diameter, area, etc.), ratios, angles, numbers, and the like disclosed in the drawings for describing the embodiments of the present disclosure are illustrative, and thus the present disclosure is not limited to the illustrated details.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

The same reference numerals refer to substantially the same components throughout the present specification. Further, in the following description of the present disclosure, when a detailed description of known related technology is determined to unnecessarily obscure the gist of the present disclosure, the detailed description thereof will be omitted herein.

When terms “provide,” “include,” “have,” “consist of,” and the like mentioned in the present disclosure are used, other parts may be added unless the term “only” is used herein. When a component is expressed in the singular, it may be interpreted as plural unless otherwise specified.

In interpreting a component, it is interpreted as including an error range even when there is no explicit description.

In describing a positional relationship, for example, when a positional relationship of two components is described as being “on,” “above,” “below,” “next to,” or the like, unless “immediately” or “directly” is used, one or more other components may be interposed between the two components.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

The terms “first,” “second,” and the like may be used to distinguish components, but the function or structure of these components is not limited by the ordinal number or component name in front of the component.

The term “unit” or “module” as used herein may include any electrical circuitry, features, components, an assembly of electronic components, or the like. That is, “unit” or “module” may include any processor-based system including systems using microcontrollers, integrated circuits, chips, microchips, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit” or “module.”

In some embodiments, the various units or modules described herein may be included in or otherwise implemented by processing circuitry such as a microprocessor, microcontroller, or the like.

The following embodiments can be partially or fully coupled to or combined with each other, and various technological interconnections and drives are possible. The embodiments may each be implemented independently from each other or may be implemented together in a related relationship.

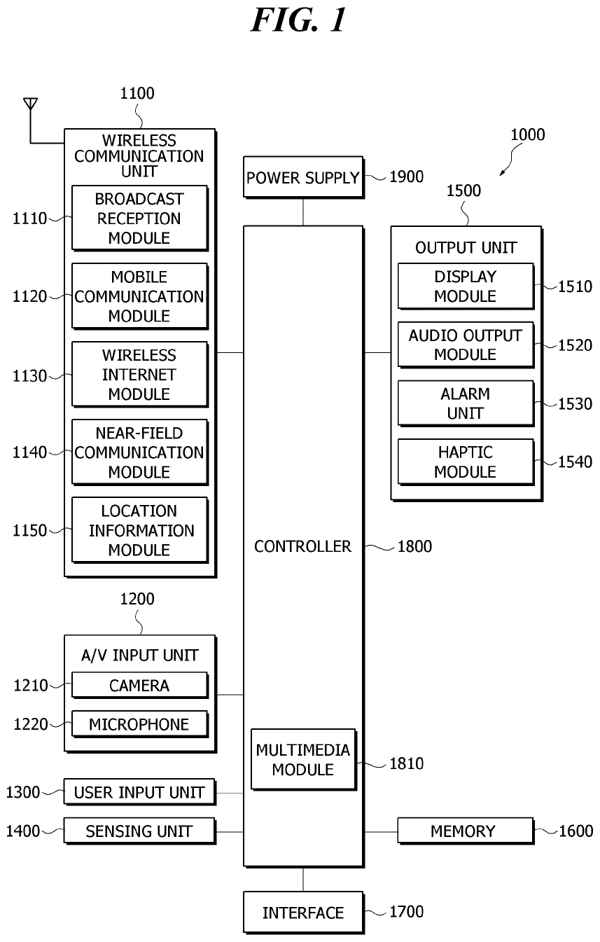

FIG. 1 is a block diagram for describing a wearable device according to the present disclosure.

Referring to FIG. 1, a wearable device 1000 according to the present disclosure may include a wireless communication unit 1100, an audio/video (A/V) input unit 1200, a user input unit 1300, a sensing unit 1400, an output unit 1500, a memory 1600, an interface 1700, a controller 1800, and a power supply 1900. Components of the wearable device 1000 are not limited to only the components shown in FIG. 1, and more components may be added or some components may be omitted according to the functions added to or omitted from the wearable device.

The wireless communication unit 1100 may include one or more modules that enable wireless communication between the wearable device 1000 and a wireless communication system or between the wearable device 1000 and a network where the wearable device 1000 is located. For example, the wireless communication unit 1100 may include a broadcast reception module 1110, a mobile communication module 1120, a wireless Internet module 1130, a near-field communication module 1140, and a location information module 1150.

The broadcast reception module 1110 receives a broadcast signal and/or broadcast-related information from an external broadcast management server through a broadcast channel. The broadcast channel may include a satellite channel and a terrestrial channel. The broadcast management server may be a server which generates and transmits a broadcast signal and/or broadcast-related information or a server which receives a previously generated broadcast signal and/or broadcast-related information and transmits the previously generated broadcast signal and/or broadcast-related information to a terminal. The broadcast signal not only may include a television (TV) broadcast signal, a radio broadcast signal, and a data broadcast signal, but also may include a broadcast signal in which the data broadcast signal is combined with the TV broadcast signal or the radio broadcast signal.

The broadcast-related information may be information related to a broadcast channel, a broadcast program, or a broadcast service provider. The broadcast-related information may also be provided through a mobile communication network. In this case, the broadcast-related information may be received by the mobile communication module 1120. The broadcast-related information may be present in various forms. For example, the broadcast-related information may be produced in the form of an electronic program guide (EPG) of digital multimedia broadcasting (DMB) or an electronic service guide (ESG) of digital video broadcast-handheld (DVB-H).

The broadcast reception module 1110 receives a broadcast signal using various broadcasting systems, and particularly, may receive a digital broadcast signal using digital broadcasting systems such as a DMB-terrestrial (DMB-T) system, a DMB-satellite (DMB-S) system, a media forward link only (MediaFLO) system, a digital video broadcast-handheld (DVB-H) system, and an integrated services digital broadcast-terrestrial (ISDB-T) system. The broadcast reception module 1110 may be configured to be suitable for not only the digital broadcasting system but also other broadcasting systems which provide broadcast signals. The broadcast signal and/or broadcast-related information received through the broadcast reception module 1110 may be stored in the memory 1600.

The mobile communication module 1120 transmits and receives a wireless signal to and from at least one of a base station, an external terminal, and a server in a mobile communication network. The wireless signal may include various types of data, such as time information, a voice call signal, a video call signal, and text/multimedia message transmission and reception.

The wireless Internet module 1130 may be a module for wireless Internet access, and the wireless Internet module 1130 may be built in or separate from the wearable device 1000.

Wireless Internet technologies may include a wireless local area network (WLAN), wireless fidelity (Wi-Fi), wireless broadband (WiBro), a world interoperability for microwave access (WiMax), and high speed downlink packet access (HSDPA).

The near-field communication module 1140 may be a module for near-field communication. Near-field communication technologies may include Bluetooth, radio frequency identification (RFID), infrared data association (IrDA), ultra-wideband (UWB), and ZigBee.

The location information module 1150 is a module for checking or acquiring a location of the wearable device. A representative example of the location information module is a global positioning system (GPS) module. The GPS module 1150 may calculate 3D location information according to a latitude, a longitude, and an altitude for a point (object) at a predetermined time by applying trigonometry to information on a distance the point (object) is from three or more satellites and distance information calculated after information on the time at which the information on the distance is measured. In addition, a method of calculating location and time information using three satellites and correcting an error in the calculated location and time information using another satellite is also used. The GPS module 1150 continuously calculates a current location in real time and uses the current location to calculate speed information.

The A/V input unit 1200 is for inputting an audio signal or a video signal and may include a camera 1210 and a microphone 1220. The camera 1210 processes an image frame such as a still image or a moving image acquired by an image sensor in a video call mode or a photographing mode. The processed image frame may be displayed on a display module 1510.

The image frame processed by the camera 1210 may be stored in the memory 1600 or transmitted externally through the wireless communication unit 1100. Two or more cameras 1210 may be installed in the wearable device 1000.

The microphone 1220 receives an external voice signal through the microphone and processes the external voice signal into electrical voice data in a call mode, a recording mode, or a voice recognition mode. In the call mode, the processed voice data may be converted into a form, which can be transmitted to a mobile communication base station, and output through the mobile communication module 1120. Various noise removal algorithms may be implemented in the microphone 1220 to remove noise generated in the process of receiving the external voice signal.

The user input unit 1300 generates input data for the user to control the operation of a terminal. The user input unit 1300 may include various types of input devices such as a key pad, a dome switch, a touch pad, a jog wheel, a jog switch, a trackball, and a joystick.

The sensing unit 1400 detects a current state of the wearable device 1000, such as an open/closed state of the wearable device 1000, a location of the wearable device 1000, whether user contact occurs, an orientation of the wearable device 1000, acceleration/deceleration of the wearable device 1000, movement of the wearable device 1000, and a change in attitude and angle to generate a sensing signal for controlling the operation of the wearable device 1000. In addition, the sensing unit 1400 may generate a sensing signal related to whether the power supply 1900 supplies power and whether the interface 1700 is coupled to an external device.

The sensing unit 1400 may include a touch screen including a touch sensor embedded in or stacked on the display module 1510, and a distance sensor 110 for detecting a face of the user and the presence or absence of an object and movement or gesture of the object within a recognizable proximity distance from the touch screen in order to transmit a stereoscopic image. In addition, the sensing unit 1400 may include a gyro sensor and a geomagnetic sensor, which detect an attitude change, an orientation change, and an angle change of the wearable device 1000. Various sensors of the sensing unit 1400, such as a touch sensor, a proximity sensor, a gyro sensor, and a geomagnetic sensor, may be used as input devices for receiving a user input.

The touch sensor may convert a change in pressure applied to a specific portion of the display 1510 or a change in capacitance occurring in a specific portion of the display 1510 into an electrical input signal. The touch sensor may detect not only a location and an area of a touch, but also a pressure at the time of a touch. When there is a touch input to the touch sensor, signal(s) corresponding to the touch input are transmitted to a touch signal processing module (not shown) of the controller 1800. The touch signal processing module calculates the coordinates of a touch point from the touch signal and transmits the coordinates to the controller 1800. The controller 1800 may detect which point on the touch screen is touched according to the coordinate values output from the touch signal processing module. When the touch sensor is implemented as a capacitive touch sensor, the proximity of a pointer may be detected by a change in electric field according to the proximity of the pointer. In this case, the touch screen may be classified as a proximity sensor.

The distance sensor 110 may be disposed inside the wearable device 1000 or near the touch screen. The distance sensor 110 may be a sensor which detects the presence or absence of an object approaching a predetermined detection surface or an object present near the sensor without mechanical contact. An indirect-time of flight (I-ToF) sensor, a direct-time of flight (D-ToF) sensor, a transmissive photoelectric sensor, a direct reflection photoelectric sensor, a mirror reflection photoelectric sensor, a high-frequency oscillation sensor, a magnetic type sensor, a ranging sensor, and an infrared sensor may be applied as the distance sensor.

The output unit 1500 is for generating an output related to a visual sense, an auditory sense, or a tactile sense and may include the display module 1510, an audio output module 1520, an alarm unit 1530, and a haptic module 1540.

The display module 1510 displays and outputs information processed by the wearable device 1000. For example, the display module 1510 may display a user interface (UI) and second-dimensional (2D) and 3D graphic user interfaces (GUIs) under the control of the controller 180. When the wearable device 1000 operates in a video call mode or a photographing mode, the display module 1510 may display an image captured by the camera 1210 or an image received through the wireless communication unit 1100.

The display module 1510 may include at least one of a liquid crystal display (LCD), a thin-film transistor LCD (TFT-LCD), an organic light-emitting diode (OLED), a flexible display, and a 3D display.

The display module 1510 may be formed as a transparent or light-transmissive type module to allow the outside to be viewed through the display panel. In this case, the user may view an object located behind a terminal body through an area occupied by the display module 1510 of a wearable device body.

In a call signal reception, a call mode or recording mode, a voice recognition mode, and a broadcast reception mode, the audio output module 1520 may output audio data received from the wireless communication unit 1100 or audio data stored in the memory 1600. The audio output module 1520 outputs an audio signal related to functions performed by the wearable device 1000 (e.g., a call signal reception sound and a message reception sound). A receiver, a speaker, and a buzzer may be included in the audio output module 1520.

The alarm unit 1530 outputs a signal for notifying the occurrence of an event in the wearable device 1000. Examples of events occurring in the wearable device include call signal reception, message reception, email reception, a key signal input, a touch input, and a proximity input. In addition to the video signal or the audio signal, the alarm unit 1530 may also output a signal for notifying the occurrence of an event in other forms, for example, vibrations. The video signal or the audio signal may also be output through the display module 1510 or the audio output module 1520.

The haptic module 1540 generates various tactile effects that the user can feel. A representative example of the tactile effect generated by the haptic module 1540 is vibration. The intensity and pattern of the vibration generated by the haptic module 1540 is controllable. For example, different vibrations may be synthesized and output or output sequentially. In addition to the vibration, the haptic module 1540 may generate a variety of tactile effects such as an effect due to stimulation by a pin array moving perpendicular to a contact skin surface, an effect due to stimulation through an air blowing force or a suction force through a nozzle or an inlet, an effect due to stimulation touching a skin surface, an effect due to stimulation through electrode contact, an effect due to stimulation using an electrostatic force, an effect due to reproducing hot and cold sensations using devices that can absorb heat or generate heat. The haptic module 1540 may be implemented not only to deliver a tactile effect through direct contact, but also to allow a tactile effect to be felt through a muscle sense of the user, such as fingers or arms.

The memory 1600 may store a program for processing various control operations of the controller 1800 and applications in various software formats and store data such as a telephone directory (or a phone book), a message, an email, a photo, and a moving image, which can be input/output under the control of the controller 1800. The memory 1600 may store data regarding various patterns of sound effects, vibration patterns, and haptic patterns, which are generated when a user input or an event occurs. The memory 1600 may include at least one type of storage medium among a flash type memory, a hard disk type memory, a multimedia card micro type memory, a card type memory (e.g., a secure digital (SD) or extreme digital (XD) memory), a random access memory (RAM), a static random access memory (SRAM), a read only memory (ROM), an electrically erasable programmable read only memory (EEPROM), a programmable read only memory (PROM), a magnetic memory, a magnetic disk, and an optical disk. The wearable device 1000 may operate in association with a web storage which performs a storage function of the memory 1600 on the Internet.

The interface 1700 serves as a passage for all external devices connected to the wearable device 1000. The interface 1700 receives data or power from an external device and transmits the power to each component in the wearable device 1000 or transmits data in the wearable device 1000 to the external device. For example, the interface 1700 may include a wired/wireless headset port, an external charger port, a wired/wireless data port, a memory card port, an identification module card port, an audio input/output (I/O) port, a video I/O port, and an earphone port. The interface 1700 may be a passage through which power from an external cradle is supplied to the wearable device 1000 when the wearable device 1000 is connected to the external cradle, or a passage through which various command signals input from the external cradle by the user are transmitted to the wearable device 1000. The various command signals or the power input from the cradle may be operated as signals to recognize that the wearable device 1000 is correctly mounted on the cradle.

The identification module is a chip which stores various types of information in order to authenticate the right to use the wearable device 1000 and may include a user identify module (UIM), a subscriber identity module (SIM), and a universal user identity module (USIM). The identification module may be manufactured in the form of a smart card. The identification module may be connected to a wearable device 1000 through the identification module port of the interface 1700. Phone numbers, call information, and billing information may be stored in the identification module.

The controller 1800 controls the overall operation of the wearable device 1000. For example, the controller 1800 performs control and processing related to a voice call, data communication, a video call, and message transmission and reception. The controller 1800 may include a multimedia module 1810. The multimedia module 1810 performs signal processing for multimedia data playback. The controller 1800 may perform pattern recognition processing capable of recognizing a handwriting input and a picture drawing input, which are performed on the touch screen, as text and an image, respectively.

The controller 1800 displays a 2D/3D user interface on the display module 1510 to allow the user to easily access various functions provided by the wearable device 1000, processes user data and commands, which are selected through the 2D/3D user interface, and executes various applications.

The controller 1800 may be implemented using at least one of application specific integrated circuits (ASICs), digital signal processors (DSPs), DSP devices (DSPDs), programmable logic devices (PLDs), field programmable gate arrays (FPGAs), micro-controllers, and microprocessors. In some cases, these embodiments may be implemented by the controller 1800.

Under the control of the controller 1800, the power supply 1900 receives external power or internal power to supply the power required for the operation of each component.

The following embodiments may be implemented in software, hardware, or a combination thereof and may be stored in a recording medium that can be read by a computer or a device similar to the computer.

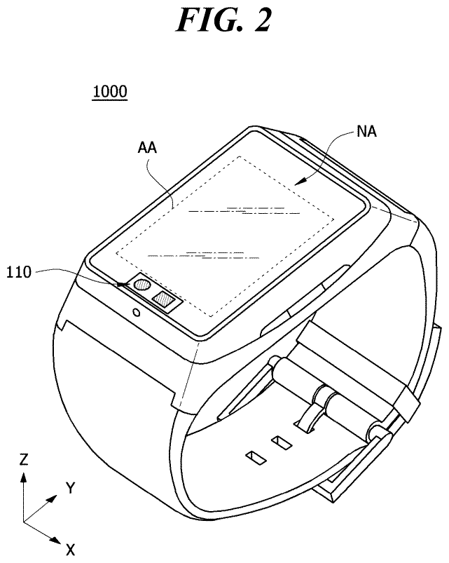

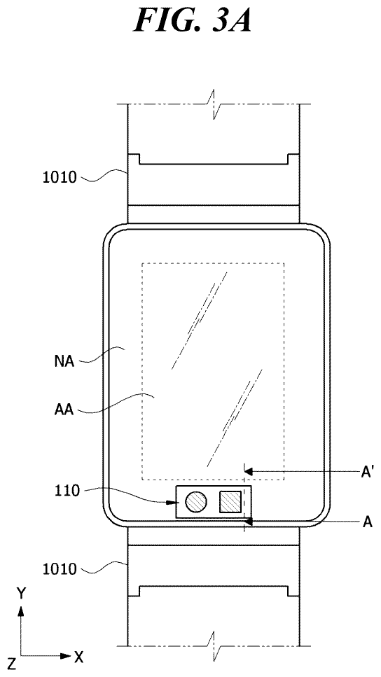

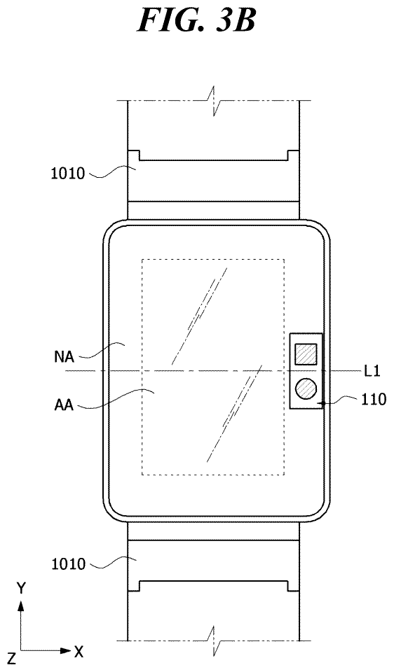

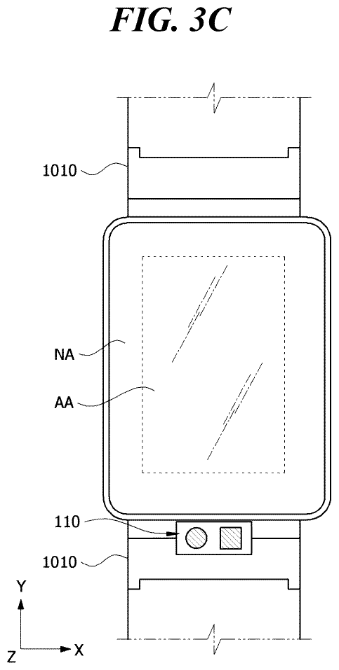

FIG. 2 is a diagram illustrating the exterior of a smart watch type wearable device. FIGS. 3A to 3C are diagrams illustrating a display unit of the wearable device in which a distance sensor is disposed according to various embodiments of the present disclosure.

Referring to FIGS. 2 to 3C, the smart watch type wearable device 1000 of the present disclosure includes the display module 1510 in which a display area AA and a non-display area NA are disposed and a strap 1010 for fixing the display module 1510 to a wrist of the user. The distance sensor 110 may be disposed in the non-display area NA.

Referring to FIG. 3A, the distance sensor 110 may be disposed on a lower end portion of the non-display area NA. Since the distance sensor 110 is disposed in the lower end portion, a distance to the face of the user may be measured more accurately.

Referring to FIG. 3B, the distance sensor 110 may be disposed in the non-display area by overlapping an imaginary line L1 that horizontally bisects the display unit of the wearable device 1000. For example, as shown, the distance sensor 110 overlaps with the non-display area of the display panel from and plan view and the imaginary line L1 from a plan view.

Since the distance sensor 110 is disposed in the middle of the non-display area NA, a distance to the user may be measured under uniform conditions even when the user wears the wearable device 1000 by rotating the wearable device 1000 regardless of a left or right side.

The present disclosure is not limited thereto, as shown in FIG. 3C, the distance sensor 110 may be disposed to be embedded in the strap 1010 disposed adjacent to and coupled to the display unit (or coupled to the device substrate). When the distance sensor 110 is disposed to be embedded in the strap 1010, the non-display area NA may be reduced to implement a narrow bezel. For example, the distance sensor 110 is embedded in the strap 101 such that the distance sensor 110 does not overlap with the display panel from a plan view. Alternatively, although not shown in the drawings, the distance sensor 110 may be disposed to overlap some of the lower end portion and a middle portion of the display area in the form of a notch.

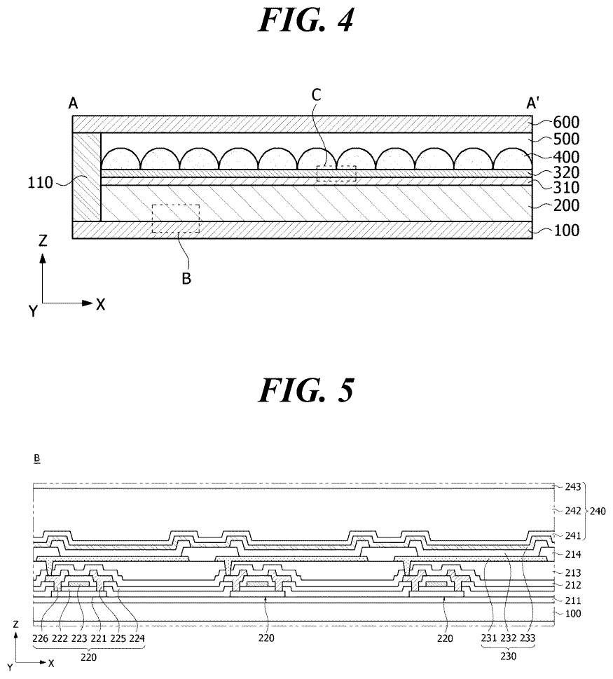

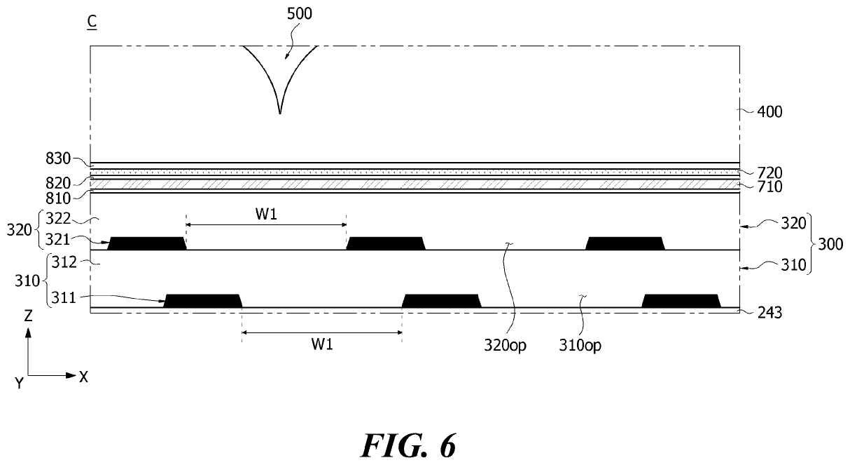

FIG. 4 is a schematic cross-sectional view along line A-A′ of FIG. 3A. FIG. 5 is an enlarged cross-sectional view of portion B of FIG. 4. FIG. 6 is an enlarged cross-sectional view of portion C of FIG. 4.

Referring to FIGS. 4 to 6, the wearable device 1000 of the present disclosure may include a device substrate 100, a display panel 200, a lower barrier layer 310, an upper barrier layer 320, lenses 400 (or in some embodiments, lenticular lenses 400), a planarization layer 500, a cover glass 600, and a distance sensor 110.

The device substrate 100 may include an insulating material. For example, the device substrate 100 may include glass or plastic.

The display panel 200 may be disposed on the substrate 100. The display panel 200 may include pixel areas PA.

Each pixel area PA may display a specific color. For example, a light-emitting element 230 located on the device substrate 100 may be located within each pixel area PA.

The light-emitting element 230 may emit light in a wavelength range exhibiting a specific color. For example, the light-emitting element 230 may include a first electrode 231, a light-emitting layer 232, and a second electrode 233, which are sequentially stacked on the device substrate 100.

The first electrode 231 may include a conductive material. The first electrode 231 may include a material with high reflectance. For example, the first electrode 231 may include metals such as aluminum (Al) and silver (Ag). The first electrode 231 may have a multi-layer structure. For example, the first electrode 231 may have a structure in which a reflective electrode made of a metal is located between transparent electrodes made of transparent conductive materials such as indium tin oxide (ITO) and indium zinc oxide (IZO).

The light-emitting layer 232 may generate light with a brightness corresponding to a voltage difference between the first electrode 231 and the second electrode 233. For example, the light-emitting layer 232 may be an emission material layer (EML) including a light-emitting material. The light-emitting material may include an organic material. For example, the display panel 200 of the 3D display device according to the embodiment of the present disclosure may be an OLED panel including a light-emitting layer 232 made of an organic material. The light-emitting layer 232 may further include at least one of a hole injection layer (HIL), a hole transport layer (HTL), an electron transport layer (ETL), and an electron injection layer (EIL) in order to increase light-emitting efficiency.

The second electrode 233 may include a conductive material. The second electrode 233 may include a material different from that of the first electrode 231. For example, the second electrode 233 may be a transparent electrode made of a transparent conductive material such as ITO or IZO. Thus, in the display panel 200 of the wearable device according to the embodiment of the present disclosure, light generated by the light-emitting layer 232 may be emitted through the second electrode 233.

A driving circuit may be located between the device substrate 100 and the light-emitting element 230. The driving circuit may apply a driving current corresponding to a data signal to the light-emitting element 230 in response to a scan signal. For example, the driving circuit may include at least one thin-film transistor 220. The thin-film transistor 220 may include a semiconductor pattern 221, a gate insulating layer 222, a gate electrode 223, an interlayer insulating layer 224, a source electrode 225, and a drain electrode 226.

The semiconductor pattern 221 may be located close to the device substrate 100. The semiconductor pattern 221 may include a semiconductor material. For example, the semiconductor pattern 221 may include silicon. The semiconductor pattern 221 may be an oxide semiconductor. For example, the semiconductor pattern 221 may include a metal oxide such as indium gallium zinc oxide (IGZO). The semiconductor pattern 221 may include a channel region located between a source region and a drain region. The source and drain regions may have electrical conductivity that is higher than that of the channel region.

The gate insulating layer 222 may be located on the semiconductor pattern 221. The gate insulating layer 222 may extend outside the semiconductor pattern 221. For example, a side surface of the semiconductor pattern 221 may be covered by the gate insulating layer 222. The gate insulating layer 222 may include an insulating material. For example, the gate insulating layer 222 may include silicon oxide or silicon nitride. The gate insulating layer 222 may include a high-k material. For example, the gate insulating layer 222 may include titanium oxide. The gate insulating layer 222 may have a multi-layer structure.

The gate electrode 223 may be located on the gate insulating layer 222. The gate electrode 223 may overlap the channel region of the semiconductor pattern 221. For example, the channel region of the semiconductor pattern 221 may have electrical conductivity corresponding to a voltage applied to the gate electrode 223. The gate electrode 223 may be insulated from the semiconductor pattern 221 by the gate insulating layer 222. The gate electrode 223 may include a conductive material. For example, the gate electrode 223 may include metals such as aluminum (Al), chromium (Cr), copper (Cu), titanium (Ti), molybdenum (Mo), and tungsten (W).

The interlayer insulating layer 224 may be located on the gate electrode 223. The interlayer insulating layer 224 may extend outside the semiconductor pattern 221. For example, a side surface of the gate electrode 223 may be covered by the interlayer insulating layer 224. The interlayer insulating layer 224 may include an insulating material. For example, the interlayer insulating layer 224 may include silicon oxide.

The source electrode 225 may be located on the interlayer insulating layer 224. The source electrode 225 may be electrically connected to the source region of the semiconductor pattern 221. For example, the gate insulating layer 222 and the interlayer insulating layer 224 may include source contact holes which partially expose the source region of the semiconductor pattern 221. The source electrode 225 may be in direct contact with the source region of the semiconductor pattern 221 within the source contact hole. The source electrode 225 may include a conductive material. For example, the source electrode 225 may include metals such as Al, Cr, Cu, Ti, Mo, and W. The source electrode 225 may include a material different from that of the gate electrode 223.

The drain electrode 226 may be located on the interlayer insulating layer 224. The drain electrode 226 may be electrically connected to the drain region of the semiconductor pattern 221. The drain electrode 226 may be spaced apart from the source electrode 225. For example, the gate insulating layer 222 and the interlayer insulating layer 224 may include drain contact holes which partially expose the drain region of the semiconductor pattern 221. The drain electrode 226 may be in direct contact with the drain region of the semiconductor pattern 221 within the drain contact hole. The drain electrode 226 may include a conductive material. For example, the drain electrode 226 may include metals such as Al, Cr, Cu, Ti, Mo, and W. The drain electrode 226 may include the same material as the source electrode 225. The drain electrode 226 may include a material different from that of the gate electrode 223.

A buffer layer 211 may be located between the device substrate 100 and the driving circuit. During a process of forming the driving circuit, the buffer layer 211 may prevent contamination due to the device substrate 100.

For example, the buffer layer 211 may be located between the device substrate 100 and the semiconductor pattern 221. The buffer layer 211 may extend outside the semiconductor pattern 221. For example, the entire surface of the device substrate 100 facing the driving circuit may be covered by the buffer layer 211. The buffer layer 211 may include an insulating material. For example, the buffer layer 211 may include silicon oxide and/or silicon nitride.

A lower protective layer 212 may be located between the driving circuit and the light-emitting element 230. The lower protective layer 212 may prevent the driving circuit from being damaged due to an external impact and moisture. For example, the lower protective layer 212 may cover the entire surface of the driving circuit facing the light-emitting element 230. The lower protective layer 212 may extend outside the source electrode 225 and the drain electrode 226. The lower protective layer 212 may include an insulating material. For example, the lower protective layer 212 may include silicon oxide and/or silicon nitride.

An overcoat layer 213 may be located between the lower protective layer 212 and the light-emitting element 230. The overcoat layer 213 may remove a step formed by the driving circuit. For example, a surface of the overcoat layer 213 facing the device substrate 100 may be a flat surface. The overcoat layer 213 may extend along the lower protective layer 212. The overcoat layer 213 may include an insulating material. The overcoat layer 213 may include a material different from that of the lower protective layer 212. For example, the overcoat layer 213 may include an organic material.

The light-emitting element 230 may be electrically connected to the driving circuit. For example, the lower protective layer 212 and the overcoat layer 213 may include electrode contact holes which expose a portion of the thin-film transistor 220. A driving current generated by the driving circuit may be applied to the first electrode 231 of the light-emitting element 230. For example, the first electrode 231 of the light-emitting element 230 may be in direct contact with the drain electrode 226 of the thin-film transistor 220 within the electrode contact hole.

An encapsulation member 240 may be located on the light-emitting element 230. For example, the light-emitting element 230 may be located between the device substrate 100 and the encapsulation member 240. The encapsulation member 240 may prevent the light-emitting element 230 from being damaged due to an external impact and moisture. The encapsulation member 240 may extend outside the light-emitting element 230. For example, the second electrode 233 of the light-emitting element 230 may be covered by the encapsulation member 240.

The encapsulation member 240 may have a multi-layer structure. For example, the encapsulation member 240 may include a first encapsulation layer 241, a second encapsulation layer 242, and a third encapsulation layer 243, which are sequentially stacked on the second electrode 233 of the light-emitting element 230. The first encapsulation layer 241, second encapsulation layer 242, and third encapsulation layer 243 may include insulating materials. The second encapsulation layer 242 may include a material different from those of the first encapsulation layer 241 and the third encapsulation layer 243. For example, the first encapsulation layer 241 and the third encapsulation layer 243 may include inorganic materials, and the second encapsulation layer 242 may include an organic material. Therefore, in the display panel 200 of the wearable device 1000 according to the embodiment of the present disclosure, infiltration of external moisture can be effectively prevented. A step formed by the light-emitting element 230 may be removed by the second encapsulation layer 242. For example, a surface of the third encapsulation layer 243 facing the device substrate 100 may be a flat surface.

The light-emitting element 230 of each pixel area PA may be controlled independently from the light-emitting elements 230 of adjacent pixel areas PA. For example, a bank insulation layer 214 may be located between adjacent pixel areas PA. The first electrode 231 of each pixel area PA may be insulated from a first electrode 231 of an adjacent pixel area PA by the first encapsulation layer 241. For example, the bank insulation layer 214 may cover an edge of each first electrode 231. The light-emitting layer 232 and the second electrode 233 of each pixel area PA may be stacked on a portion of a corresponding first electrode 231 exposed by the bank insulation layer 214. The bank insulation layer 214 may include an insulating material. For example, the bank insulation layer 214 may include an organic material. The bank insulation layer 214 may include a material different from that of the overcoat layer 213.

The light-emitting element 230 of each pixel area PA may implement a different color from a light-emitting element 230 of an adjacent pixel area PA. For example, the light-emitting layer 232 of each light-emitting element 230 may include a material different from that of a light-emitting layer 232 of an adjacent light-emitting element 230. The light-emitting layer 232 of each light-emitting element 230 may be spaced apart from a light-emitting layer 232 of an adjacent light-emitting element 230. For example, the light-emitting layer 232 of each light-emitting element 230 may include an end portion located on the bank insulation layer 214.

The same voltage as that of a second electrode 233 of an adjacent pixel area PA may be applied to the second electrode 233 of each pixel area PA. For example, the second electrode 233 of each light-emitting element 230 may be electrically connected to a second electrode 233 of an adjacent light-emitting element 230. The second electrode 233 of each light-emitting element 230 may include the same material as a second electrode 233 of an adjacent light-emitting element 230. For example, the second electrode 233 of each light-emitting element 230 may be in contact with a second electrode 233 of an adjacent light-emitting element 230. The bank insulation layer 214 may be covered by the second electrode 233.

The lenses 400 may be located on the display panel 200. In some embodiments, the lenses 400 include a semi-circular cross-section. In some embodiments, the lenses have a lenticular shape and therefore, is referred to as lenticular lenses. The lenticular lenses 400 may generate a 3D image in a set region using light emitted from each pixel area PA of the display panel 200. For example, the wearable device 1000 according to the embodiment of the present disclosure may be a light field display apparatus (LFD) in which light emitted from each pixel area of the display panel overlaps in a set region by the lenticular lenses 400.

A barrier layer 300 may be located between the display panel 200 and the lenticular lenses 400. The barrier layer 300 may have a multi-layer structure. For example, the barrier layer 300 may have a structure in which a lower barrier layer 310 (may also be referred to as a first barrier layer 310) and an upper barrier layer 320 (may also be referred to as a second barrier layer 320) are stacked.

The lower barrier layer 310 may be located close to the display panel 200. For example, the lower buffer layer 310 may be located between the third encapsulation layer 243 and the upper barrier layer 320. The lower barrier layer 310 may include lower barrier patterns 311 and lower openings 310op located between the lower barrier patterns 311.

The lower barrier pattern 311 may include a light blocking material. For example, the lower barrier pattern 311 may include a metal. The lower barrier pattern 311 may include a material with low reflectance. For example, the lower barrier pattern 311 may include a black dye. Therefore, light emitted from each pixel area PA of the display panel 200 may pass through one of the lower openings 310op of the lower barrier layer 310. The lower opening 310op may correspond to the pixel area PA of the display panel 200.

For example, each lower opening 310op may have the same width W1 as a corresponding pixel area PA of display panel 200.

The lower barrier layer 310 may be formed using the process of manufacturing the display panel 200. For example, an operation of forming the lower barrier layer 310 may include a process of forming a light blocking material layer on the encapsulation member 240 of the display panel 200 and a process of forming the lower barrier patterns 311 by patterning the light blocking material layer. The lower barrier patterns 311 may be in direct contact with the third encapsulation layer 243 of the display panel 200.

The upper barrier layer 320 may be located on the lower barrier layer 310. For example, the upper barrier layer 320 may be located between the lower barrier layer 310 and the lenticular lenses 400. The upper barrier layer 320 may include upper barrier patterns 321 and upper openings 320op located between the upper barrier patterns 321.

The upper barrier pattern 321 may include a light blocking material. For example, the upper barrier pattern 321 may include a metal. The upper barrier pattern 321 may include a material with low reflectance. For example, the upper barrier pattern 321 may include a black dye. The upper barrier pattern 321 may include the same material as the lower barrier pattern 311.

Light emitted from each pixel area PA of the display panel 200 may pass through a corresponding lower opening 310op and a corresponding upper opening 320op to travel in a direction of the lenticular lenses 400. The upper openings 320op may correspond to the lower openings 310op. For example, a width of each upper opening 320op may be equal to the width W1 of each lower opening 310op.

A decrease in brightness of light emitted from each pixel area PA of the display panel 200 can be prevented by the barrier layer 300.

The upper barrier layer 320 may be formed using the process of manufacturing the display panel 200. For example, an operation of forming the upper barrier layer 320 may include a process of forming a light blocking material layer on the lower barrier layer 310 and a process of forming upper barrier patterns 321 by patterning the light blocking material layer.

A surface of the upper barrier layer 320 facing the display panel 200 may be parallel to a surface of the display panel 200 facing the lenticular lenses 400. For example, the lower barrier layer 310 may include a lower planarization layer 312 which covers the lower barrier patterns 311. The lower planarization layer 312 may remove steps formed by the lower barrier patterns 311. A surface of the lower planarization layer 312 facing the lenticular lenses 400 may be a flat surface. For example, the lower openings 310op may be filled with the lower planarization layer 312. The lower planarization layer 312 may include an insulating material.

For example, the lower planarization layer 312 may include an organic material. The lower barrier layer 310 may be in direct contact with the display panel 200 and the upper barrier layer 320. For example, the upper barrier patterns 321 may be in direct contact with the lower planarization layer 312.

A ¼ wave plate 710 and a linear polarizer 720 may be stacked between the barrier layer 300 and the lenticular lenses 400. The ¼ wave plate 710 and the linear polarizer 720 may prevent external light from being reflected by the display panel 200. For example, the linear polarizer 720 may be located between the ¼ wave plate 710 and the lenticular lenses 400. A surface of the ¼ wave plate 710 facing the display panel 200 may be flat.

For example, the upper barrier layer 320 may include an upper planarization layer 322 which covers the upper barrier patterns 321. The upper planarization layer 322 may remove steps formed by the upper barrier patterns 321. For example, the upper openings 320op may be filled with the upper planarization layer 322. The upper planarization layer 322 may include an insulating material. For example, the upper planarization layer 322 may include an organic material. The upper planarization layer 322 may include the same material as the lower planarization layer 312. A space between the lower barrier layer 310 and the ¼ wave plate 710 may be completely filled with the upper barrier layer 320. For example, the ¼ wave plate 710 may be in direct contact with the upper planarization layer 322.

The ¼ wave plate 710, the linear polarizer 720, and the lenticular lenses 400 may be fixed on the barrier layer 300. For example, in the 3D display device according to the embodiment of the present disclosure, the ¼ wave plate 710 may be attached to the upper barrier layer 320 by a first adhesive layer 810, the linear polarizer 720 may be attached to the ¼ wave plate 710 by a second adhesive layer 820, and the lenticular lenses 400 may be attached to the linear polarizer 720 by a third adhesive layer 830. Thus, no air gap may be formed between the display panel 200 and the lenticular lenses 400.

The first adhesive layer 810, the second adhesive layer 820, and the third adhesive layer 830 may include different materials. For example, a refractive index of the first adhesive layer 810 may be different from a refractive index of the second adhesive layer 820 and/or a refractive index of the third adhesive layer 830. The first adhesive layer 810 may have a refractive index between a refractive index of the upper planarization layer 322 of the upper barrier layer 320 and a refractive index of the ¼ wave plate 710. The second adhesive layer 820 may have a refractive index between the refractive index of the ¼ wave plate 710 and a refractive index of the linear polarizer 720. The third adhesive layer 830 may have a refractive index between the refractive index of the linear polarizer 720 and a refractive index of the lenticular lenses 400. The refractive index of the first adhesive layer 810 may be the same as that of the ¼ wave plate 710, and the second adhesive layer 820 and the third adhesive layer 830 may have the same refractive index as the linear polarizer 720.

The planarization layer 500 may be disposed on the lenticular lenses 400 to flatten the curvature of an upper portion thereof due to the lenses. The cover glass 600 may be disposed on the upper portion planarized by the planarization layer 500.

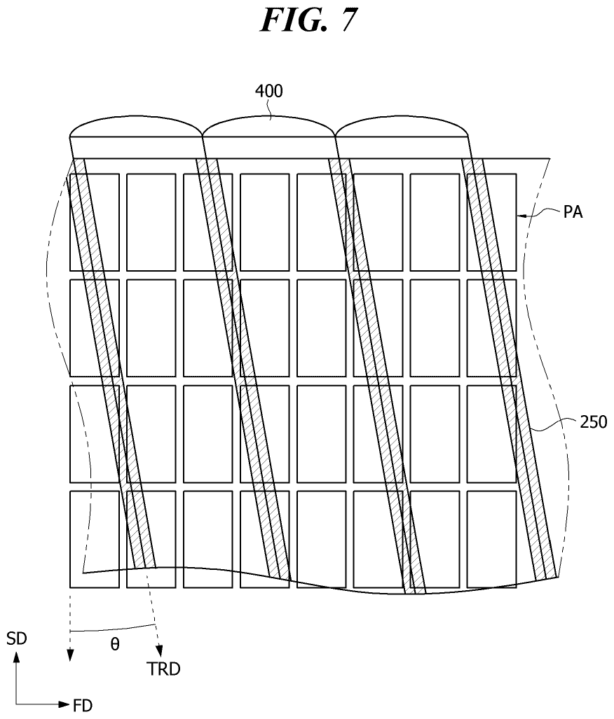

FIG. 7 is a diagram illustrating a display panel further including light blocking patterns for preventing the generation of partial images in the display panel.

Referring to FIG. 7, the display panel 200 may further include light blocking patterns 250 for preventing the generation of partial images. The light blocking patterns 250 may overlap the boundaries of the lenticular lenses 400 from a plan view. The display panel 200 may include the pixel areas PA located side by side in a first direction FD and a second direction SD perpendicular to the first direction. For example, the pixel areas PA may be disposed in the form of a matrix. Each lenticular lens 400 may extend in a third direction TRD at an angle θ with respect to the second direction. Each light blocking pattern 250 may extend parallel to the lenticular lenses 400.

The light blocking pattern 250 may include a light blocking material. For example, the light blocking pattern 250 may include a metal. The light blocking pattern 250 may include a material with low reflectance. For example, the light blocking pattern 250 may include a black dye. The light blocking patterns 250 may include the same materials as the lower barrier patterns and the upper barrier patterns.

Light emitted from each pixel area PA of the display panel 200 in a boundary direction of the lenticular lenses 400 may be blocked by the light blocking patterns 250.

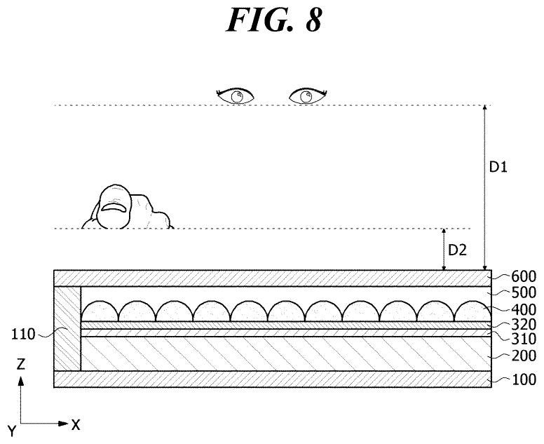

FIG. 8 is a diagram illustrating an effective sensing distance and a hovering sensing distance.

Referring to FIG. 8, the distance sensor 110 disposed in the non-display area NA may measure a distance from the cover glass 600 to the face of the user and a finger gesture for operating the wearable device.

In displaying stereoscopic images, in order to increase the resolution of stereoscopic images, there are various attempts to control image information entering both eyes by applying eye-tracking technology using camera sensors to track a position of an eye in real time and allow appropriate stereoscopic images to be viewed. However, in this case, in a small wearable device such as a smart watch, there is a problem in that excessive computation is required to control stereoscopic image information.

In addition, when a finger for manipulating a wearable device approaches the wearable device and a camera sensor, there is a problem in that the distance sensor does not track the finger and does not transmit a correct stereoscopic image.

When a distance measured by the distance sensor 110 is an effective sensing distance D1, which is considered suitable for displaying a stereoscopic image, the controller may recognize that the measured object is the face of the user.

The controller sets a field of view (FOV) θ2 of the stereoscopic image suitable for the effective distance, and the display panel 200 transmits the stereoscopic image suitable for the FOV.

When the distance measured by the distance sensor 110 is less than or equal to a distance D2 suitable for hovering, the controller may analyze a movement direction of the measured object and operate a hovering application linked to the distance sensor to operate the wearable device. The distance sensor detects hovering patterns (e.g., a distance, a proximity direction, a proximity speed, a proximity time, a proximity location, and a proximity movement state). Information corresponding to the detected proximity motion and proximity touch pattern may be output on the display module.

The effective sensing distance D1 may range from 25 cm to 35 cm from the cover glass 600 of the wearable device 1000. A range of the distance D2 suitable for hovering may range from 5 cm to 10 cm from the cover glass 600 of the wearable device 1000.

When the distance measured by the distance sensor 110 is not the effective sensing distance D1 suitable for displaying the stereoscopic image or the distance D2 suitable for hovering, the controller 1800 transmits a signal for outputting a general image to the display module of the output unit, and the display panel 200 of the display module outputs the general image.

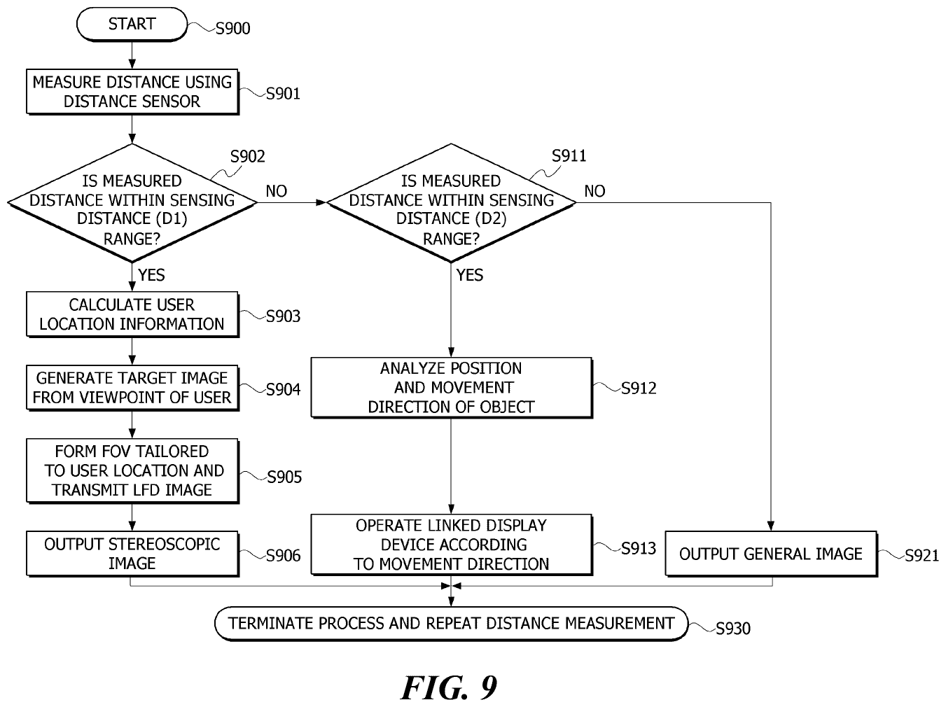

FIG. 9 is a flowchart illustrating an example of a sensing method using a distance sensor.

Referring to FIG. 9, a distance to the face of the user or a finger gesture for operating the wearable device is measured using the distance sensor 110 disposed in the wearable device 1000 (S901).

In one or more embodiments, the distance sensor concurrently measures both a face of a user and a finger of the user.

When the measured distance is less than or equal to the effective sensing distance D1 suitable for displaying a preset stereoscopic image (S902), the controller 1800 calculates user location information on the basis of the distance information (S903), generates a target image from the viewpoint of the user (S904), forms an FOV according to the user's location, and transmits a signal for outputting a general image to the display module of the output unit (S905).

The display panel 200 of the display module transmits a stereoscopic image on the basis of the received signal (S906).

When the measured distance is less than or equal to the distance D2 suitable for hovering (S911), a position and a movement direction of an object such as a finger within the hovering range are analyzed on the basis of the measured information (S912). According to the analyzed movement direction and action, the controller 1800 operates an application linked to the distance sensor (S913).

When the measured distance is over both the effective sensing distance D1 suitable for outputting the stereoscopic image and the hovering distance D2, the controller 1800 transmits a signal for outputting a general image to the display module of the output unit, and the display panel 200 of the display module outputs the general image (S921).

After a series of processes are processed, the controller 1800 reanalyzes the distance information received from the distance sensor (S930).

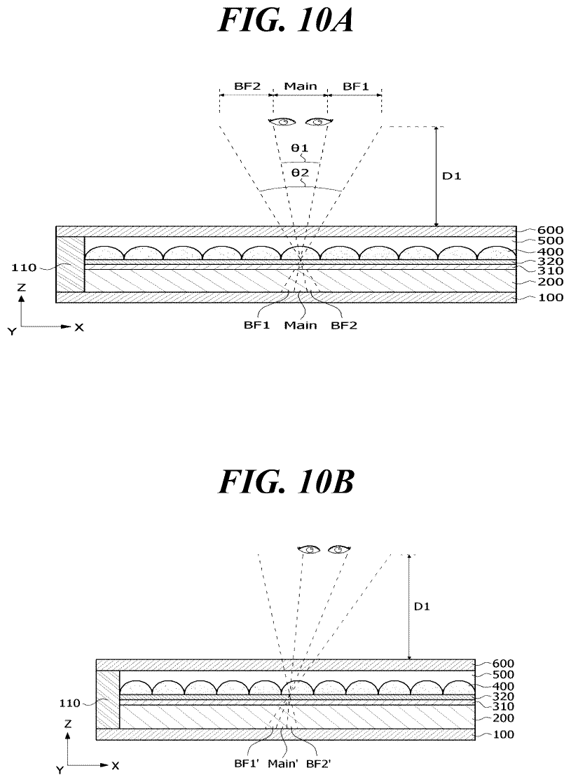

FIGS. 10A and 10B are diagrams illustrating a change in an image section within a display panel when a user moves within an effective sensing distance range.

Referring to FIGS. 10A and 10B, when a stereoscopic image is displayed on the display panel 200, the display panel 200 may display the stereoscopic image by setting an inner region of the display panel 200, which corresponds to an angle θ1 including a gap between the eyes of the user in a region of the FOV θ2 displaying the stereoscopic image, as a basic display region Main.

Left and right regions corresponding to angles, excluding the angle θ1 including the distance between the eyes of the user in the FOV θ2, may be set as buffer regions BF1 and BF2, respectively.

As shown in FIG. 10B, when the center of the user's position measured by the distance sensor moves and deviates from the section of the basic display region, by changing the viewpoint information of a video disposed on the panel located in the buffer region BF in advance, when the user moves within the effective sensing distance D1, the stereoscopic image may be displayed continuously.

When the buffer region BF is changed to a basic display region Main′, in the display panel 200, the left and right regions corresponding to an angle, excluding the angle θ1 including the gap between the eyes of the user in the FOV θ2 of the basic display region Main′, may be changed to the buffer regions BF1′ and BF2′ to respond to additional slight movements of the face of the user.

According to the present disclosure, when a user views from an initially set fixed location, by using only information sufficient to determine which direction (angle) the user is present based on a screen of the wearable device using a distance sensor such as a time of flight (ToF) sensor, image processing is performed to form a viewing angle of a stereoscopic image based on the determined direction so that excessive computation within the wearable device can be prevented.

According to the present disclosure, when a distance measured by a distance sensor is a set effective sensing distance, a stereoscopic image can be displayed, and when the distance is a hovering sensing distance, an application linked to the distance sensor can be performed.

It should be noted that effects of the present disclosure are not limited to the above-described effects, and other effects of the present disclosure will be apparent to those skilled in the art from the appended claims.

Through the above description, those skilled in the art will appreciate that various changes and modifications are possible without departing from the technical idea of the present disclosure. Therefore, the present disclosure should not be limited to the content described in the detailed description of the specification.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable device comprising:
a display panel including a display area in which pixels are disposed and a non-display area adjacent to the display area;
a barrier layer on the display area;
a lenticular lens layer on the barrier layer; and
a distance sensor either in the non-display area or outside the display panel.

2. The wearable device of claim 1, further comprising light blocking patterns disposed to overlap a boundary of the lenticular lens layer.

3. The wearable device of claim 1, wherein the distance sensor includes one or more of an indirect-time of flight sensor, a direct-time of flight sensor, and a camera sensor.

4. The wearable device of claim 3, wherein the distance sensor is disposed on a lower end portion of the non-display area.

5. The wearable device of claim 3, wherein the distance sensor is disposed in the non-display area to overlap an imaginary line that bisects the wearable device in a horizontal direction, and
wherein the distance sensor overlaps the imaginary line from a plan view.

6. The wearable device of claim 1, wherein the barrier layer includes:
a lower barrier layer; and
an upper barrier layer on the lower barrier layer,
wherein the upper and lower barrier layers partition a plurality of openings.

7. The wearable device of claim 1, further comprising:
a cover glass layer on the lenticular lens layer; and
a planarization layer between the lenticular lens layer and the cover glass layer.

8. The wearable device of claim 3, wherein, when a distance measured by the distance sensor is within an effective sensing distance range suitable for displaying a stereoscopic image, the stereoscopic image is displayed on the display panel.

9. The wearable device of claim 8, wherein, when the distance measured by the distance sensor is within a range in which hovering sensing is possible, an application linked to the distance sensor is executed.

10. The wearable device of claim 9, wherein the effective sensing distance range is longer than the hovering sensing range.

11. The wearable device of claim 8, wherein, when the stereoscopic image is displayed, the display panel is divided into a basic display region through which the stereoscopic image is displayed to a user and buffer regions disposed on both sides of the basic display region.

12. The wearable device of claim 11, wherein:
the buffer region is changed to the basic display region when the user moves within the effective sensing distance range; and
buffer regions are disposed on both sides of the changed basic display region.

13. The wearable device of claim 3, wherein the distance sensor concurrently measures both a face of a user and a finger of the user.

14. A method of driving a wearable device, comprising:
measuring, by a distance sensor, a face or finger of a user;
calculating, by a controller, user location information based on a measured distance being within a sensing distance range;
transmitting, by a display module, a stereoscopic image based on a location of the user;
analyzing, by the distance sensor, a location and a movement direction of an object within a hovering range based on the measured distance being within a hovering distance range;
executing, by a controller, a linked application of the wearable device based on the movement direction; and
outputting a general image based on the measured distance being both outside of the hovering distance range and the sensing distance range suitable for outputting the stereoscopic image.

15. A wearable device comprising:
a device substrate;
a display panel including a display area in which pixels are disposed and a non-display area adjacent to the display area;
a barrier layer on the display panel;
a lens layer on the barrier layer; and
a distance sensor adjacent to the device substrate.

16. The wearable device of claim 15, further comprising:
a strap coupled to the device substrate,
wherein the distance sensor is located in the strap such that the distance sensor does not overlap with the display panel from a plan view.

17. The wearable device of claim 15, wherein the distance sensor overlaps with the non-display area of the display panel from a plan view, and
wherein the distance sensor includes a time of flight sensor.

18. The wearable device of claim 15, wherein the lens layer includes one or more lenses that have a semi-circular cross-section,
wherein the barrier layer includes a first barrier layer,
wherein the first barrier layer includes:
a plurality of first barrier patterns spaced apart from each other, and
a first opening between adjacent first barrier patterns of the plurality of first barrier patterns.

19. The wearable device of claim 18, wherein the barrier layer includes a second barrier layer on the first barrier layer, and
wherein the second barrier layer includes:
a plurality of second barrier patterns spaced apart from each other, and
a second opening between adjacent second barrier patterns of the plurality of second barrier patterns,
wherein a first barrier pattern of the plurality of first barrier patterns overlaps with a second barrier pattern of the plurality of second barrier patterns from a plan view, and
wherein the plurality of first and second barrier patterns include a metal.

20. The wearable device of claim 19, wherein a width of the first opening and a width of the second opening are the same as each other.

21. The wearable device of claim 15, further comprising:
light blocking patterns in the display panel,
wherein the lens layer includes one or more lenses that have a semi-circular cross-section,
wherein each lens of the one or more lenses has a boundary,
wherein the light blocking patterns overlap with the boundary of the one or more lenses from a plan view.
